(19) United States
(12) Patent Application Publication
(10) Pub. No.: US 2022/0012435 A1
(43) Pub. Date: Jan. 13, 2022

(54) PORTABLE TEXT CAPTURE AND TRANSLATOR DEVICE

(71) Applicant: Cody Parrott, Davis, OK (US)

(72) Inventor: Cody Parrott, Davis, OK (US)

(21) Appl. No.: 16/924,054

(22) Filed: Jul. 8, 2020

(51) Int. Cl. G06F 40/58; G06K 9/34; G06F 40/242; G06F 40/211; G06F 40/263

(52) U.S. Cl. CPC G06F 40/58; G06K 9/344; G06K 2209/01; G06F 40/211; G06F 40/263; G06F 40/242

(57) ABSTRACT

A computer device for translating text in a captured image comprises a camera coupled to a CPU for capturing an image including text and a touch sensitive display forming a GUI. The CPU analyzes digital image data with an optical character recognition software module to recognize and extract language characters and text and then executes a language translation module to translate the extracted language characters and text from a first language into a second language and apply syntax rules to refine the translation. The CPU generates an image of the translated second language text onto the GUI display. A memory in the computer device stores a plurality of language character and dictionary libraries as a group of first languages for translating into at least one second language. Multiple translations based on alternative definitions can be reviewed for selecting a best definition from a set of alternative translations.

### CROSS REFERENCE TO RELATED APPLICATIONS

Not applicable.

### FIELD OF INVENTION

The present invention relates to the field of image processing to capture and extract text and language translators, and, more particularly, to a portable computer device used to recognize text in a first language and translate the text into a second language.

### BACKGROUND

International travelers frequently encounter text that they lack the knowledge to read. For example, an English or French tourist traveling in China generally be unable to read Chinese logographic writing and will be unable to decipher and understand street signs, menus, building signs, documents, or museum displays. Those same tourists may also want to read ancient hieroglyphs in Egypt, ancient Hebrew in Israel, or ancient Greek in Greece. Multi-disciplinary archelogy teams may encounter artifacts in a number of languages at a single site ranging from Norse runes, to ancient Latin, and even potentially Mesopotamian cuneiform script or ancient Greek; all at the same site.

The need to translate from one language to another requires a tool to translate computer screens, TV screens, books, signs, stickers, printed papers, manuscripts, labels, or any other material with any language written on it. Various potential users can be engaged in any number of industries such as technology, tourism, banking, governments, information technology, manufacturing, archeology, medicine, or national defense (the military). Specific user can also include tourists, missionaries, clergy, churches, hikers, translators, scholars, teachers, schools, librarians, businesspeople, researchers, archeologists, students, medical personnel, guides, airline employees, bar tenders, car rental employees, hotel clerks, and restaurant wait staff.

Many translators currently available have considerable problems in the translation because of stark differences in the syntax rules for the languages and multiple different definitions for the same word. There is thus a need for a translator that corrects syntax errors and permits review of multiple translations based on different definitions.

Based on the foregoing, there is a need in the image processing and translator field for an easily carried apparatus for capturing an image of text and processing that image data to extract text in first language, identify the specific language of the text, translate the text from the first language into a second language, and display the translation on a GUI.

### SUMMARY

In an embodiment, a computer device for translating text in a captured image comprises a camera coupled to a CPU for capturing an image including text and a touch sensitive display forming a GUI. The CPU operates an image processing software module to convert captured image data into digital image data. The CPU analyzes the image data with an optical character recognition software module to recognize and extract language characters and text and then executes a language translation module to translate the extracted language characters and text from a first language into a second language and apply syntax rules to refine the translation. The CPU generates an image of the translated second language text onto the GUI display. A non-transitory memory in the computer device stores a plurality of language character and dictionary libraries as a group of first languages for translating into at least one second language.

In an embodiment, a non-transitory memory device can be used to configure a computer device CPU to capture and translate text data from an image that comprises stored software that includes multiple software modules, text data for at least a first language in a group of languages, a dictionary for the first language, and syntax rules for the first language to translate into a second language, uploadable to a non-transitory memory of the computer device. An image processing module processes captured image data to convert into digital data. An optical character recognition module recognizes and extracts language characters and text. A language translation module translates the extracted language characters and text from a first language into a second language and applies the syntax rules to refine the translation. The computer device includes a display for displaying translated characters and text.

A method for converting text on an object from a first language into a second language comprises the steps of: capturing an image with text with a camera on a computer device; processing image data to convert captured image data into digital image data; performing optical character recognition to recognize and extract language characters and text from the digital image data; translating recognized and extracted language characters and text from a first language into a second language including applying syntactic rules to refine the translation using data stored in a non-transitory memory on the computer device; and generating an image of the translated second language text onto a GUI display.

Additionally, in an embodiment, the invention generates multiple text translations in a first set text of translations that can be reviewed by a user. The user can alter a translated word/character from a first translation to a second alternative translation, and then select a best translation.

In yet another embodiment, the invention converts text on an object from a first language into a second language that comprises generating a first set of text translations from a first language into a second language; reviewing ones of the first set of text translations; using the display GUI to alter a translated word/character from at least one of the ones of the first set of translations to a second alternate translation by selecting from among a plurality of displayed alternative definitions for at least a portion of first language text; and generating at least one refined translation from at least one second alternate translation based at least in part on a syntax rule.

Advantages:

1. Improved translation accuracy and understanding by applying syntax rules to refine the translation.

2. Correction for anomalies in the image data.

3. Generation of alternative translations for review.

4. Selection of a best translation.

5. Generating a refined translation applying syntax rules and alternative translations.

6. Recognizing and extracting language characters and text to include logographic or phonemic orthographic writing.

7. Correcting for damaged or missing textual elements based on context.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 depicts an exemplary schematic depicting a block diagram of components of a computer device configured to translate captured text images, according to an embodiment of the present invention;

FIG. 2 depicts an exemplary schematic depicting a block diagram of components of a compact device to capture text images and translate captured text images, according to an embodiment of the present invention;

FIG. 3 depicts an exemplary front side view of the translator device, according to an embodiment of the present invention;

FIG. 4 depicts an exemplary back side view of the translator device, according to an embodiment of the present invention;

FIG. 5 depicts an exemplary left side view of the translator device, according to an embodiment of the present invention;

FIG. 6 depicts an exemplary right side view of the translator device, according to an embodiment of the present invention;

FIG. 7 depicts an exemplary top view of the translator device, according to an embodiment of the present invention;

FIG. 8 depicts an exemplary bottom view of the translator device, according to an embodiment of the present invention

FIG. 9 depicts an exemplary process flow chart of a method for translating text on a medium, according to an embodiment of the present invention;

FIG. 10 depicts an exemplary process flow chart for selecting an alternate translation from a set of alternative translations, according to an embodiment of the present invention; and

FIG. 11 depicts alternative display options for displaying original text along with translated text, according to an embodiment of the invention.

### DETAILED DESCRIPTION OF PREFERRED EMBODIMENTS

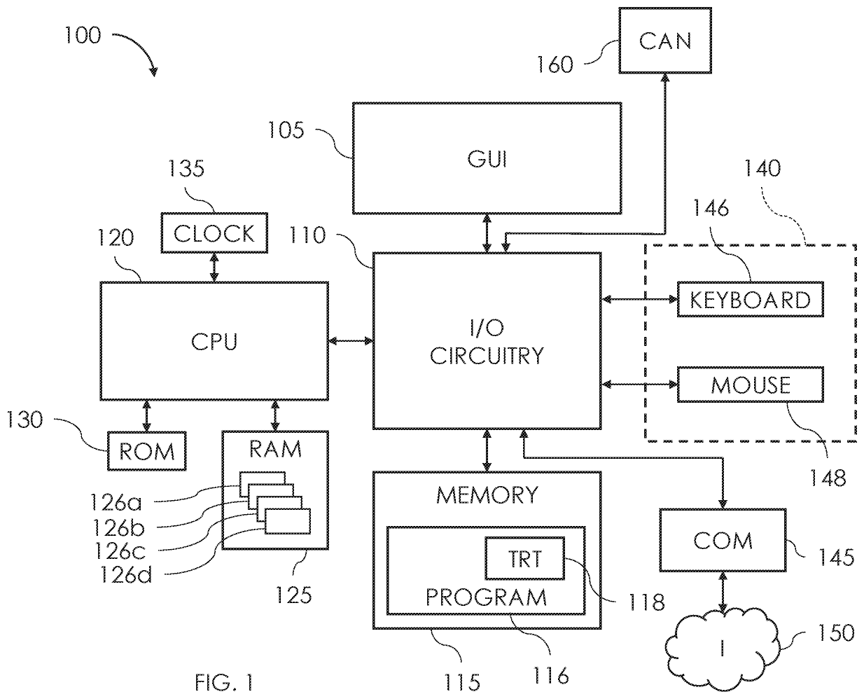

Preferred embodiments of the present invention and their advantages may be understood by referring to FIGS. 1-11, wherein like reference numerals refer to like elements.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub combination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

Devices or system modules that are in at least general communication with each other need not be in continuous communication with each other, unless expressly specified otherwise. In addition, devices or system modules that are in at least general communication with each other may communicate directly or indirectly through one or more intermediaries.

The computer memories in the various disclosed devices may store computer executable instructions. Each disclosed computer/communication device such as a computer, a server, a system node, a smart phone, a tablet, or similar device able to execute computer code and/or process digital, electronic data may execute computer executable instructions. The computer executable instructions may be included in computer code. The computer code may be stored in the various device memories. The computer code may be written in any computer language comprising the prior art. The memory may be a non-transitory tangible storage media such as a compact disk (CD), flash drive, floppy disk, micro disc card, hard disc drive (HDD), solid-state drive (SDD), or similar type of storage device or media capable of storing computer code (e.g., software code) in a non-transitory and computer-accessible state. Sophisticated computer apps have increasingly become available, with downloaded executable software code (e.g., the Apple® Store) providing for configuring a mobile device, such as a smart phone or tablet, to perform a plethora of functions. In some applications, a smaller compact mobile device, such as a tablet or smart phone, can be connected to a laptop or desktop computer by a USB hard-wired or Bluetooth® wireless connection to configure or reconfigure the device with new or updated software or data.

The computer code may be logic encoded in one or more tangible media or one or more non-transitory tangible media for execution by the processor in the devices. Logic encoded in one or more tangible media for execution may be defined as instructions that are executable by the processor and that are provided on the computer-readable storage media, memories, or a combination thereof. Logic may include a software controlled microprocessor, an application specific integrated circuit (ASIC), an analog circuit, a digital circuit, a programmed logic device, a memory device containing instructions, and the like. The instructions may be stored on any computer readable medium comprising the prior art from which a computer, a processor, or other electronic device can read. This may include a computer data disk or the like storing computer code that can be used to configure a memory associated with a computer, a processor, or other electronic device.

The processor may include a general processor, digital signal processor, ASIC, field programmable gate array, analog circuit, digital circuit, central processing unit (CPU), micro-processor unit (MPU), micro-controller unit (MCU), combinations thereof, or other now known processor. The processor may be a single device or combinations of devices, such as associated with a network or distributed processing. The processor may be responsive to or operable to execute instructions stored as part of software, hardware, integrated circuits, firmware, micro-code or the like. The functions, acts, methods or tasks illustrated in the figures or described herein may be performed by the processor executing instructions stored in the memory.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

As depicted in FIG. 1, a schematic block diagram 100 shows the internal components of a computer smartphone, laptop, desktop, or tablet (or similar computer/communication device) that can comprise a display 105 comprising a touch sensitive screen functioning as a graphical user interface (GUI), input/output (I/O) circuity 110 for processing and routing input and output data, memory 115 storing digital data, which can include computer programs (in the form of executable program code) 116, including the text recognition and translator (TRT) 118 of the invention as well as an associated language text database (LTB), a central processing unit (CPU) 120, with associated Random Access Memory (RAM) 125 consisting of RAM modules 126a, 126b, 127c, and 126d, Read Only Memory (ROM) 130, a clock 135 regulating the function of the device, and external hardwire 140 that may be attached, such as a keyboard 146 or a mouse 148, which also can serve as a GUI. However, typically touch inputs on the touch sensitive display/GUI 105, which may also include virtual graphical analogues of the mouse 148 and keyboard 146. Finally, the device can include a communication interface (COM) 145 for accessing the Internet 150 and transmitting or receiving data between the device and external data sources, such as a computer server hosting an Internet accessible website. COM 145 can support communication over a cellular mobile network, WAN, WiFi, Bluetooth®, or similar wireless connection to interface or communicate with other devices. Using these communication resources, COM 145 can access and communicate over the Internet 150 or use a short range wireless connection to a nearby device. A camera 160 can be used to capture images and manipulate using image processing software and/or TRT program 118 on the CPU 120 or store image data in the memory 115. In one such application, a larger device can be used to update or configure a smaller, compact mobile device with software or language data.

In operation, the CPU 120 can access through I/O circuitry 110 memory 115 storing programs 116 including the SB 118 of the invention. The CPU 120 can execute the programs 116 as well as processing any stored digital data in memory 115. The CPU 120 can also operate to process data received or transmitted via communication interface COM 145 or by camera 160 using I/O circuitry 110. The CPU 120 can process received data from or transmitted to communication interface 145 as well as data manipulation inputs from the GUI screen 105 of the tablet or exterior hardware 140. As noted above, CPU 120 can be used with applicable image processing and text recognition/optical character recognition programs to utilize in conjunction with language translating software (TRT 118) to produce a translated image of captured text. The touch sensitive screen forming GUI 105 can receive data inputs reflecting scrolling or swiping movements of a user's finger, which the CPU 120, utilizing executed programs from memory 115, uses to process data received from COM 145 to display that data reflecting those scrolling and swiping inputs from a user on screen 105.

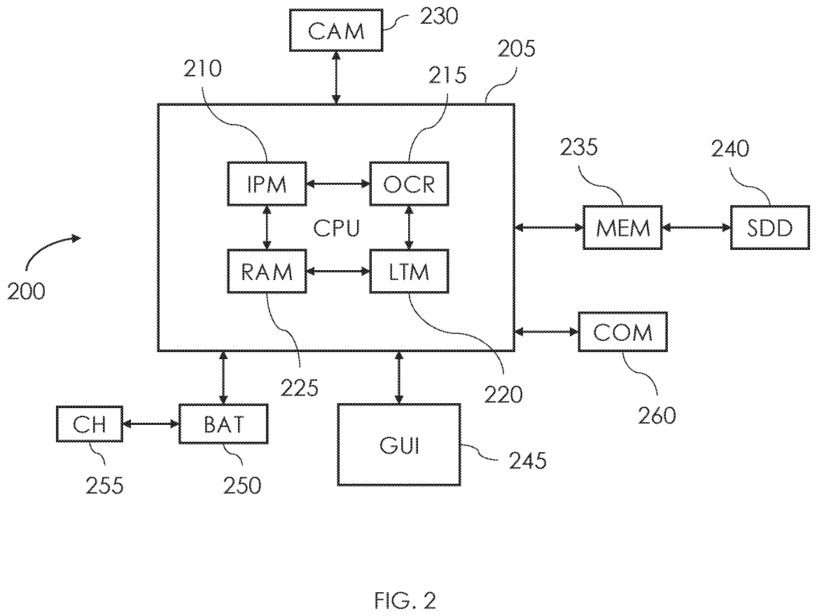

As depicted in FIG. 2, a schematic block diagram 200 shows the internal components of a dedicated pocket translator device of the invention. CPU 205 operates an image processing module (IPM) 210, an optical character recognition (OCR) module 215, and a language translation module (LTM) 220. CPU 205 uses random access memory (RAM) 225 to execute the various software modules to process captured image data, to recognize text, and translate that text from one language to another. Camera (CAM) 230 can be used by the device to capture text images provided to the CPU 205.

A non-transitory memory (MEM) 235 can store the TRT 118 software program (which includes IPM 230, OCR 215, and LTM 220) to run on CPU 205 when in use. MEM 235 can comprise a compact HDD or SDD. MEM 235 can also interface with a removable SDD chip 240 to update a language library stored on the MEM 235.

It is contemplated that a plurality of SDD chips 240 may be available with each SDD chip 244 storing one or more groups of language libraries, dictionaries, and syntax rules necessary for the combination OCR 215 and LTM 205 to configure the device to operate for a given group of languages. For example, an archeologist working in southern Tukey may need an SDD chip 240 to configure the device to recognize and translate Egyptian hieroglyphs, Latin, ancient Hebrew, ancient Greek, ancient Hittite and ancient Assyrian, and Arabic into English or another specific language. An Asian traveler may need an SDD chip 240 storing a library consisting of Japanese, Chinese, Korean, and Russian language. Optionally or additionally, a communication interface (COM) 260 linked to CPU 205 can be used to update the language and dictionary library stored in MEM 235 using a wireless connection to the Internet 150 or larger computer or even using a wired connection.

A GUI 245 comprised of a touch sensitive display screen can be used to control the device and display the captured image, extracted untranslated text, and translated text. The device itself can be powered by battery (BAT) 250 and a charger (CH) 255 can be used to recharge the battery or alternatively power the device.

The group of available languages stored in the language and dictionary libraries can be related by family or geographic area. For example, the group of languages may be related by commonly encountered languages in a region such as a group of Slavic languages to include Russian, Ukrainian, Polish, Bulgarian, and Czech. Or the languages may be related by research area, such as Egyptian hieroglyphs, Aramaic, Phoenician, ancient Greek, ancient Hebrew, or Sumerian script. The memory in the device is intended to store at least one group of languages, and SDD chip language modules, and, in a preferred embodiment, can be used to swap out groups of stored languages to create a customized group of languages selected by a user from multiple SDD languages modules or selected and downloaded by interfacing with the Internet using COM 260. For example, a scholar might want two or three SDD chips with the necessary databases to recognize and translate a dozen languages or more. Further, the dictionaries for these languages may include syntactic rules to further refine the translations to improve accuracy and understanding. It can be used to translate a paragraph of information at a time from computer screens, TV screens, books, signs, stickers, printed papers, manuscripts, or any other material with any language on it

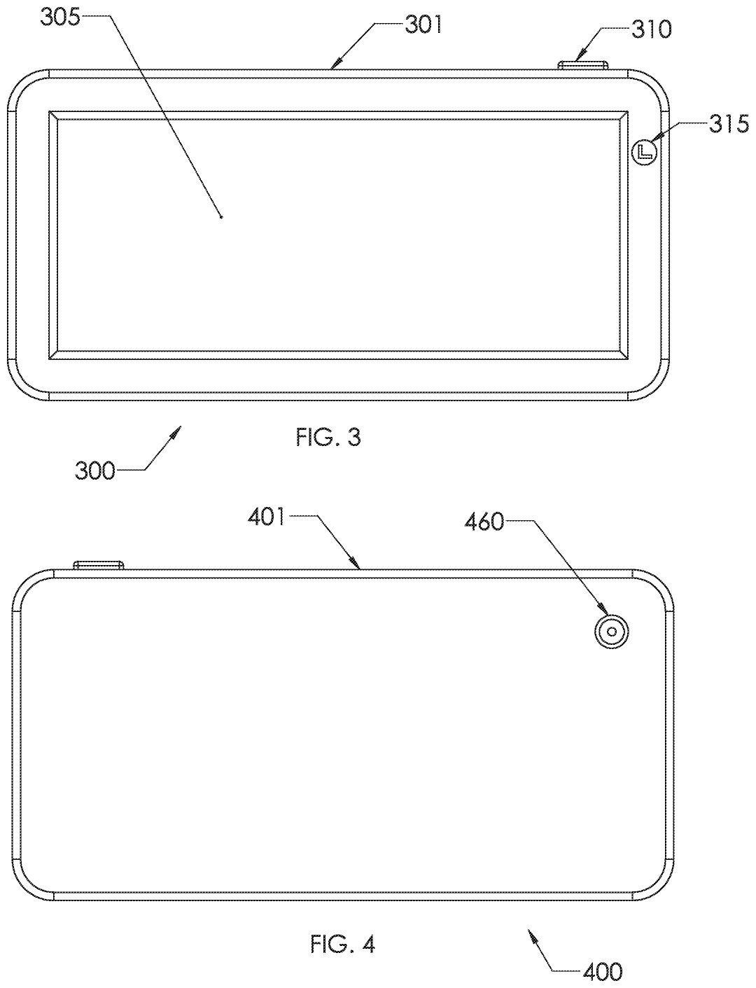

FIG. 3 depicts an exemplary front side 300 of the translator device. Front 301 of the front side 300 includes GUI 305 comprises a touch sensitive display screen, which can include virtual displayed analogs of a keyboard and mouse. The screen itself can provide mouse-like inputs through finger swipes across the screen and taps on the GUI 305 screen. Power button 310 can be used to turn the device on and off. Language button (L) 315 can be utilized to select a language or language library, including a dictionary, stored in MEM 235, a language to translate captured text into, and to toggle the view between the original text and the translated text.

FIG. 4 depicts an exemplary back side 400 of the translator device. Back 401 of the back side 400 includes camera 460 for capturing a text image to translate. Image data captured by camera 460 is processed using IPM 210 by the CPU 205 so that the OCR module 215 can recognize text for translation by the LTM 220. The translated text can be displayed on GUI 305.

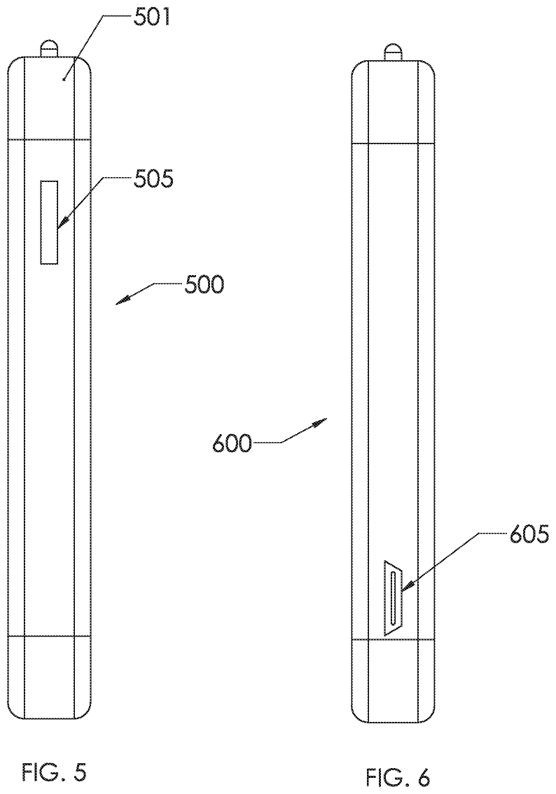

FIG. 5 depicts an exemplary left side 500 of the translator device. Left side surface 501 can include an SDD slot 505 to receive an SDD chip 240 and download stored data onto CPU 205 and store in MEM 235.

FIG. 6 depicts an exemplary right side 600 of the translator device. Right side surface 601 can include a universal charge port 605 to charge an internal battery BAT 250.

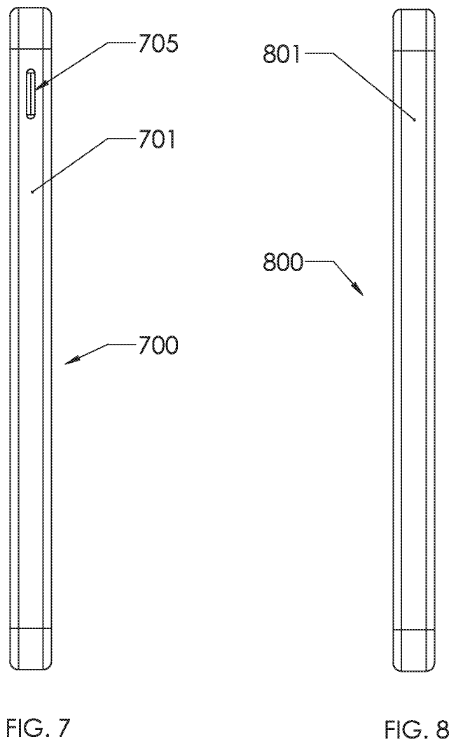

FIG. 7 depicts an exemplary top view 700 of the translator device. Top side surface 701 can include power switch 705, which can comprise an on/off button.

FIG. 8 depicts an exemplary bottom view 800 of the translator device, which comprises bottom side surface 801.

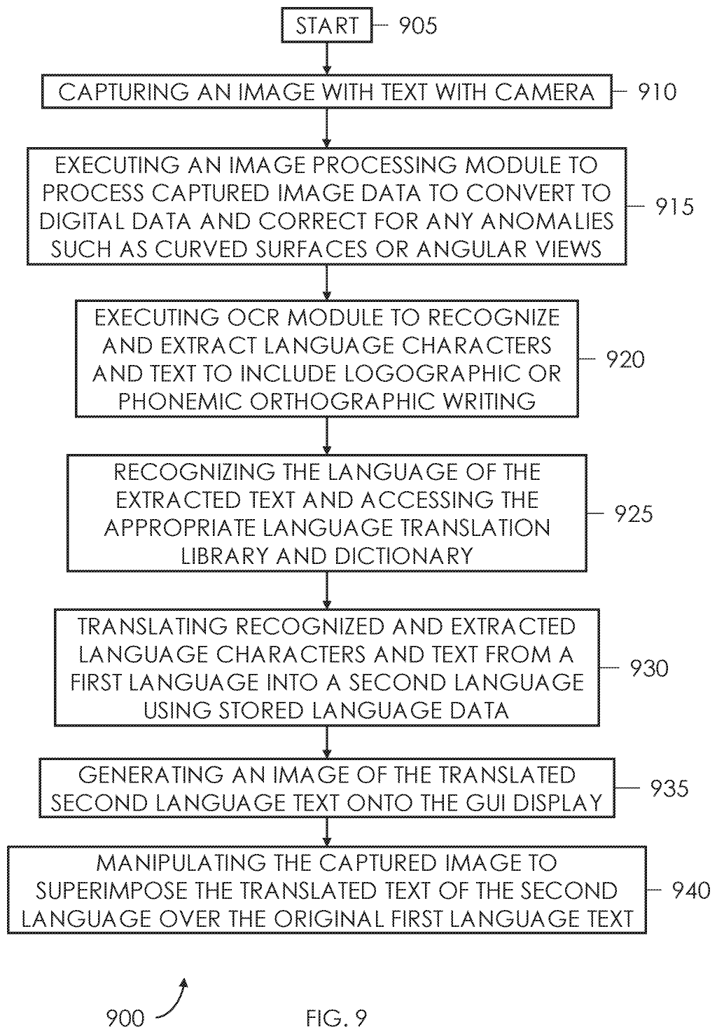

FIG. 9 depicts an exemplary process flow 900 for translating text on a printed medium, such as a sign, label, menu, sculpture, engraving, manuscript, or the like according to the present invention. The process starts at 905. In step 910, the process 900 operates to capture an image with text with camera 230. Next in step 915, the CPU executes an image processing module to process captured image data to convert to digital data and correct for any anomalies such as curved surfaces or angular views. The visual anomalies can include curved or angular views, an irregular image, broken surface, damaged textual elements, or other anomalies in the image data. A somewhat typical application can include capture of text off of pottery fragments or compete vases, pots, or other items of crockery or decorative pottery, masonry, or stone or metal statutes, or monuments, or even manuscripts. However, the device is not limited in this respect and can be used to capture writing of any medium.

In step 920, the process executes the OCR module to recognize and extract language characters and text to include logographic or phonemic orthographic writing. The process in step 925 can include recognizing language of the extracted text and accessing the appropriate language translation library. This can be performed by a user manually using language button L 325 or automatically as the OCR 215 and LTM 230 perform a comparison to determine and decipher the language of the captured text. A user can also manually control the device with the GUI 245. This step may be the first step performed, as a user may first select the language of the text being captured and the translated language. The GUI 245 can be used in some embodiments to set up the translator device for the language being captured, the language to translate the text into and display, or set up processing or displaying options.

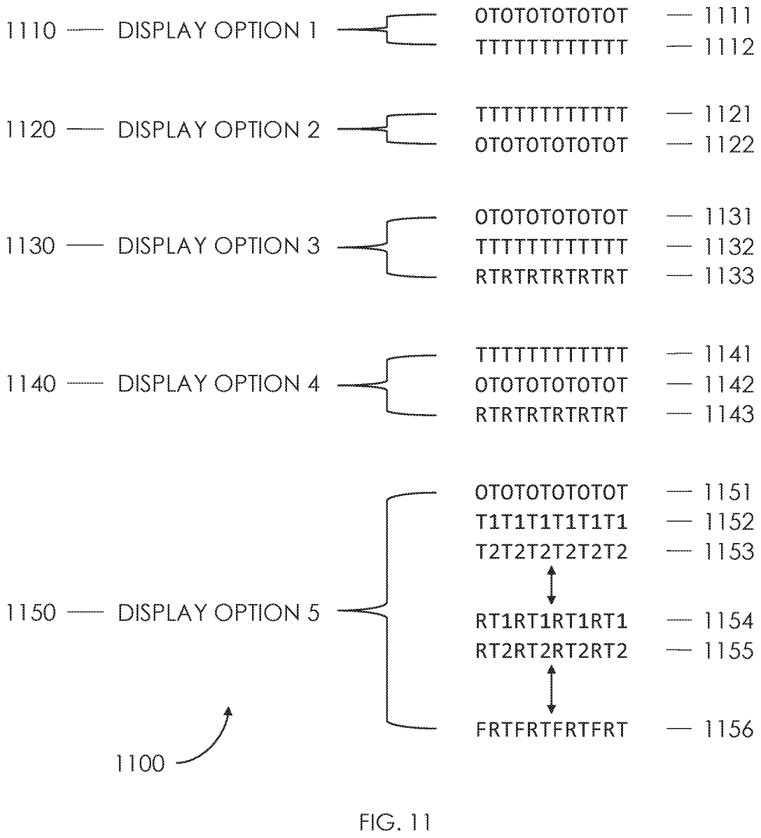

In step 930, the process can translate recognized and extracted language characters and text from a first language into a second language using stored language data (e.g., translation data, dictionary data, logographic data, and/or character data, etc) and apply stored syntactic rules to refine the translation. This can include appropriate software to recognize and translate alternate character data for common writing variations such as script. As pointed out above, the first language and the second language can be manually selected using L button 325 or GUI 245. Alternatively, the first language can be automatically detected by the OCR module 215 or the IPM 230. In step 940, the process can generate an image of the translated second language text displayed onto the GUI 245. Optionally, the TRT program 118 can manipulate the captured image to superimpose the translated text of the second language over the original first language text in the original image. Other display options are detailed in FIG. 11.

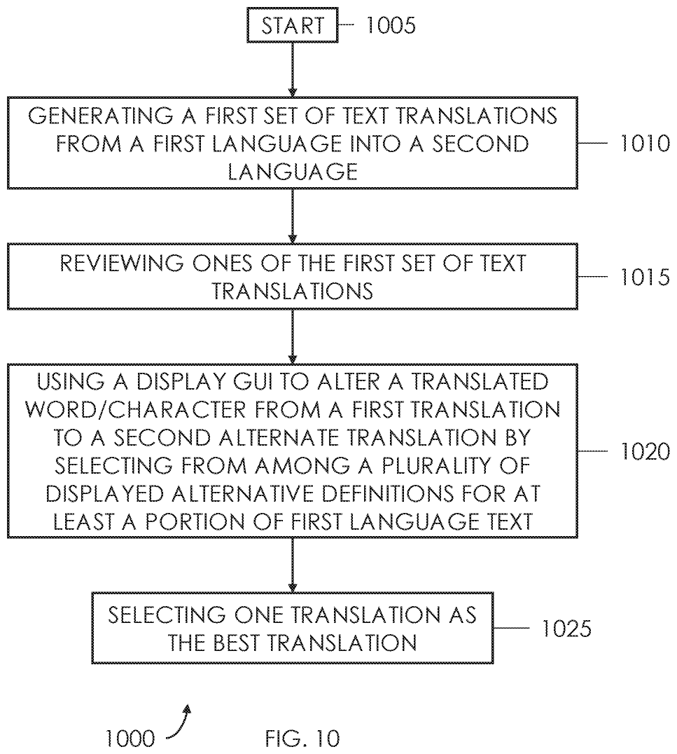

FIG. 10 depicts a second exemplary process flow 1000 for reviewing and adjusting multiple translated versions of text. Words in every language can have multiple meanings, and translations from a first language into a second language can give rise to multiple translations of the same text. The process starts at step 1005. In step 1010, the program generates a first set of text translations from a first language into a second language. This first set of translations includes two or more alternative translations based on different definitions of at least one portion of the text. In step 1015, the user can review the ones of the first set of text translations, which includes at least two or more different versions of translated text based on alternative definitions or characters. In step 1020, the user uses a display GUI 245 to alter a translated word/character from a first translation to a second alternate translation by selecting from among a plurality of displayed alternative definitions or interpretations of characters for at least a portion of first language text. Then, in step 1025, the user can select one translation as the best translation using a GUI 245 input. Thus, the user can manually review alternative translations of an area of text and select one that translates best in context. Additionally, syntax rules for the languages can be applied to generate a refined translation.

FIG. 11 shows several options for displaying original, untranslated text and/or characters and translated text. Five exemplary options 900 are depicted. In Display Option 1, Original Text (OT) 1111 is displayed positioned directly above Translated Text (TT) 1112 on the GUI 245. The device GUI 245 permits a user to manipulate and edit TT 1112 by selecting OT 1111 to explore and select among alternative definitions as shown on TT 1112. Display Option 2 1120 is functionally identical Display Option 1 1110, except this displays TT 1121 above OT 1122. In Display Option 3 930, three lines of text are depicted. The top line depicts untranslated OT 1131 above TT 1132 with a line of Refined Translation (RT) 1133 text applying syntactic rules at the bottom. Again, a user can manipulate and edit TT 1132 and RT 1133 by selecting OT 1131 to explore and select among alternative definitions for a portion of OT 1131 as shown on both TT 1132 and RT 1133. Display Option 4 1140 is essentially identical, except that TT 1141 constitutes the top line, OT 1142 is the second line, and RT 1143 constitutes the third line. These options can facilitate a user selecting portions of original text to explore alternative translations displayed simultaneously as translated text and refined translations.

In Display Option 5 1150, the first, top line comprises the OT 1151, but there are now a plurality of alternative translations shown based on alternative definitions and/or alternative interpretations of language characters. Translation 1 (T1) 1152 depicts a first alternative text translation, and Translation 2 (T2) 1153 depicts a second alternative text translation. Again, a user can interact with portions of OT 1151 using GUI 245 to look at alternative meanings and adjust the translation. However, in this option, the device can apply syntax rules to generate Refined Text 1 (RT1) 1154 and Refined Text 2 (RT2) 1155. Further, the device can generate a line of Final Recommended Translation (FRT) 1156 containing a best translation according to context and/or syntax rules for one or both of the original language or the translated language. Again, the user can use GUI 245 to adjust the meaning of portions of the OT 1151 giving rise to instant real-time adjustments to the depicted translations 1152, 1153, 1154, 1155 to finally generate FRT 1156.

This real-time ability to manipulate and view alternate translations can aid improvements to interpreting translations in context and improve accuracy and clarity of the translation. Moreover, a user can perform multiple manipulations to generate a plurality of alternate translations “on-the-fly” to arrive at a best FRT 1156. In some embodiments, a user may also be able to use COM 220 to connect with an Internet-based resource to help with a translation if the FRT 1156 of the original text appears non-sensical or in some other manner does not match the overall context of one or more other sections of text.

Of course, the above display options are not exhaustive. Various arrangements of original text, alternative translations, alternative refined translations, and final recommended translations can be shown on GUI 245. The device can be utilized to generate multiple variations of translations to generate an FRT result. In some embodiments, the device can be configured as well to account for various slang or informal meanings unique to differences in regional dialects or local social usages. For example, the device can be configured to account for differences between Classical Latin and Vulgar Latin or High German and Low German. Furthermore, the apparatus can allow for custom configurations of various display options. Importantly, these display options can include overlays over the original object that can allow for display of, for example, literal translations as well as FRTs either simultaneously or sequentially. For example, a literal or original translation may display as “small darkly wolf see walk fast quick far” to an FRT that reads as “see the black baby wolf running very fast in the distance.”

Insofar as the description above and the accompanying drawing disclose any additional subject matter that is not within the scope of the single claim below, the inventions are not dedicated to the public and the right to the one or more applications to claim such additional inventions is reserved.

Of course the present invention is not intended to be restricted to any particular form or arrangement, or any specific embodiment, or any specific use, disclosed herein, since the same may be modified in various particulars or relations without departing from the spirit or scope of the claimed invention hereinabove shown and described of which the apparatus or method shown is intended only for illustration and disclosure of an operative embodiment and not to show all of the various forms or modifications in which this invention might be embodied or operated.

The foregoing has described methods and systems for a patient movement monitoring and feedback system that are given for illustration and not for limitation and uses. Thus, the inventions are limited only by the appended claims. Although the inventions have been described in accordance with the embodiments shown, one of ordinary skill in the art will readily recognize that there could be variations to the embodiments and those variations would be within the spirit and scope of the present inventions. Accordingly, many modifications may be made by one of ordinary skill in the art without departing from the spirit and scope of the appended claims.

Particular terminology used when describing certain features or aspects of the embodiments should not be taken to imply that the terminology is being redefined herein to be restricted to any specific characteristics, features, or aspects with which that terminology is associated. In general, the terms used in the following claims should not be construed to be limited to the specific embodiments disclosed in the specification, unless the above Detailed Description section explicitly defines such terms. Accordingly, the actual scope of the claims encompasses not only the disclosed embodiments, but also all equivalent ways of practicing or implementing the claimed subject matter.

The above detailed description of the embodiments is not intended to be exhaustive or to limit the disclosure to the precise embodiment or form disclosed herein or to the particular fields of usage mentioned above. While specific embodiments and examples are described above for illustrative purposes, various equivalent modifications are possible within the scope of the disclosure, as those skilled in the relevant art will recognize. Also, the teachings of the embodiments provided herein can be applied to other systems, not necessarily the system described above. The elements and acts of the various embodiments described above can be combined to provide further embodiments.

Any patents, applications and other references that may be listed in accompanying or subsequent filing papers, are incorporated herein by reference. Aspects of embodiments can be modified, if necessary, to employ the systems, functions, and concepts of the various references to provide yet further embodiments.

In light of the above “Detailed Description,” the Inventors may make changes to the disclosure. While the detailed description outlines possible embodiments and discloses the best mode contemplated, no matter how detailed the above appears in text, embodiments may be practiced in a myriad of ways. Thus, implementation details may vary considerably while still being encompassed by the spirit of the embodiments as disclosed by the inventors. As discussed herein, specific terminology used when describing certain features or aspects should not be taken to imply that the terminology is being redefined herein to be restricted to any specific characteristics, features, or aspects of the embodiments with which that terminology is associated.

While certain aspects are presented below in certain claim forms, the inventors contemplate the various aspects in any number of claim forms. Accordingly, the inventors reserve the right to add additional claims after filing the application to pursue such additional claim forms for other aspects.

The above specification, examples and data provide a description of the structure and use of exemplary implementations of the described systems, articles of manufacture and methods. It is important to note that many implementations can be made without departing from the spirit and scope of the disclosure.

### Modifications and Variations

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

The device can comprise a computer device configured using a CD, SDD, or Internet connection to download the TRT software or data updates including language updates for a translation library.

In another embodiment, the translator device can be a dedicated compact device with an Internet connection option to update a language library store in memory or access a translator server if translator computing resources are insufficient to support the translation.

The libraries and dictionaries including syntax data can be set up as a second language specific in that the first language program database are used to translate into a single, specific language (e.g., English). However, the system can be designed and setup to translate a group of languages into a plurality of selectable second languages. For example, the second language of the device can be set to selectively translate text into English, Spanish, or Arabic.

Translated and original text can be arranged for display and storage on internal memory or downloaded onto external memory such as a removable SDD chip or the Internet Cloud or another computer using a wireless communication.

Various translator modes can be implemented on the device. This might include manuscript translation where the device is optimized to capture an entire page of text on a document. Another mode may be a masonry or monument mode where the device is optimized to capture text from a building including both flat, curved, or irregular surfaces. Yet another mode may be statutory mode to optimize the device for extracting text from a statue, or crockery mode to optimize the device for extracting text from vases, pots, or other example of storage or decorative pottery items. There may also be a fragmented mode, where the device captures a partial text image, such as from several shards, and can offer multiple translations with various interpretations for missing textual/characters elements.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

I claim:

1. A computer device for translating text in a captured image, comprising:
a camera coupled to a CPU for capturing an image including text and a touch sensitive display forming a GUI;
said CPU operating an image processing software module to convert captured image data into digital image data;
the CPU analyzing the image data with an optical character recognition software module to recognize and extract language characters and text;
the CPU executing a language translation module to translate the extracted language characters and text from a first language into a second language and applying syntax rules to refine the translation;
the CPU generating an image of the translated second language text onto the GUI display; and
a non-transitory memory in the computer device storing a plurality of language character and dictionary libraries as a group of first languages for translating into at least one second language.

2. The computer device for translating text in a captured image of claim 1, further comprising:
the non-transitory memory storing translation software and libraries of character and text including dictionaries and syntax rules, that includes logographic and/or phonemic orthographic writing, for the plurality of first languages for translation into at least one second languages;
a communication interface for updating data stored in the non-transitory memory.

3. The computer device for translating text in a captured image of claim 1, further comprising:
the non-transitory memory storing translation software and libraries of character and text including dictionaries and syntax rules, that includes logographic and/or phonemic orthographic writing, for the plurality of first languages for translation into at least one second languages;
a SDD chip slot for receiving a SDD chip storing data to upload into the non-transitory memory.

4. The computer device for translating text in a captured image of claim 1, further comprising the GUI providing control inputs into the computer device.

5. The computer device for translating text in a captured image of claim 1, further comprising the language translation module operating to automatically detect the language of the captured characters and text, select the appropriate translation library and dictionary from the group of languages, and apply syntactic rules to refine the translation.

6. The computer device for translating text in a captured image of claim 1, further comprising:
the CPU generates a first set of text translations from the first language to the second language; and
a GUI input selecting one translation from the first set of translations as the best translation.

7. The computer device for translating text in a captured image of claim 6, further comprising a GUI input to alter a translated word/character from the first translation to a second alternate translation by selecting from among a plurality of displayed alternative definitions for at least a portion of the first language text.

8. The computer device for translating text in a captured image of claim 1, further comprising image processing to correct anomalies in the image.

9. The computer device for translating text in a captured image of claim 8, wherein the anomalies can include curved views, angular views, an irregular image, broken surface, or damaged textual elements.

10. A non-transitory memory device used to configure a computer device CPU to capture and translate text data from an image, comprising:
stored software that includes multiple software modules, text data for at least a first language in a group of languages, a dictionary for the first language, and syntax rules for the first language to translate into a second language, uploadable to a non-transitory memory of the computer device;
an image processing module for processing captured image data to convert to digital data;
an optical character recognition module to recognize and extract language characters and text;
a language translation module for translating the extracted language characters and text from the first language into the second language and applying the syntax rules to refine the translation;
wherein the computer device includes a display for displaying translated characters and text in the second language.

11. The non-transitory memory device used to configure a computer device CPU to capture and translate text data from an image of claim 10, wherein the configured CPU can process the image data to correct anomalies in the image data.

12. The non-transitory memory device used to configure a computer device CPU to capture and translate text data from an image of claim 10, wherein the anomalies can include at least one of the following:
curved views;
angular views;
irregular images;
broken surfaces; and
damaged or missing textual elements.

13. The non-transitory memory device used to configure a computer device CPU to capture and translate text data from an image of claim 10, wherein the configured CPU can manipulate the captured image to superimpose the translated text of the second language over the original first language text.

14. A method for converting text on an object from a first language into a second language, comprising the steps of:
capturing an image with text with a camera on a computer device;
processing image data to convert captured image data into digital image data;
performing optical character recognition to recognize and extract language characters and text from the digital image data;
translating recognized and extracted language characters and text from a first language into a second language including applying syntactic rules to refine the translation using data stored in a non-transitory memory on the computer device to generate a final recommended translation; and
generating an image of the translated second language text onto a GUI display.

15. The method for converting text on an object from a first language into a second language of claim 14, further comprising the steps of:
storing translation software and a library of character and text including a dictionary for translations comprising logographic and phonemic orthographic writing; and
updating data stored in a non-transitory memory associated with a translation software module.

16. The method for converting text on an object from a first language into a second language of claim 14, comprising the steps of:
storing translation software and a library of character and text comprising a dictionary for translations including logographic and phonemic orthographic writing;
updating the translation software or library or dictionary data with data stored on a SDD chip.

17. The method for converting text on an object from a first language into a second language of claim 14, further comprising the step of providing control inputs into the computer device using the GUI.

18. The method for converting text on an object from a first language into a second language of claim 14, further comprising the steps of:
detecting the language of the captured characters and text; and
selecting the appropriate translation library, dictionary, and associated syntactic rules.

19. The method for converting text on an object from a first language into a second language of claim 14, further comprising image processing to correct anomalies in the image.

20. The method for converting text on an object from a first language into a second language of claim 14, further comprising the steps of:
generating a first set of text translations from the first language into the second language;
reviewing at least one of the first set of text translations;
using the display GUI to alter a translated word/character from at least one of the first set of translations to a second alternate translation by selecting from among a plurality of displayed alternative definitions for at least a portion of first language text; and
generating at least one refined translation from at least one second alternate translation based at least in part on a stored syntax rule.
